(19) United States
(12) Patent Application Publication
(10) Pub. No.: US 2025/0095022 A1
(43) Pub. Date: Mar. 20, 2025

(54) SYSTEM AND METHOD FOR AUGMENTING TIME SERIES DATA

(71) Applicant: Walmart Apollo, LLC, Bentonville, AR (US)

(72) Inventors: Sourit Manna, Bengaluru (IN); Shankhadeep De, Bangalore (IN); Subrahmanya Kiran Sripada, Bangalore (IN); Anshul Bansal, Bengaluru (IN)

(21) Appl. No.: 18/467,976

(22) Filed: Sep. 15, 2023

(51) Int. Cl. G06Q 30/0242; G06Q 30/0272

(52) U.S. Cl. CPC G06Q 30/0242; G06Q 30/0272

(57) ABSTRACT

Systems and methods for augmenting time series data are disclosed. In some embodiments, a disclosed method includes: storing, in a database, current time series data associated with a plurality of users, receiving, from the database, the current time series data, wherein the current time series data is associated with a current time period, generating synthetic historical time series data based on the current time series data, and combining the current time series data and the synthetic historical time series data to generate augmented time series data.

### TECHNICAL FIELD

This application relates generally to advertising campaigns and, more particularly, to systems and methods for augmenting time series data for long term forecasting.

### BACKGROUND

An advertisement may be a presentation or communication to promote an item, such as a product or service, for purchase. At least some advertisements are digital advertisements, which include a digital representation of the presentation or communication, such as one displayed on a website. A sponsor of an advertisement, such as a business, may seek to sell the item in the advertisement. The sponsor may advertise the item in the advertisement to notify potential buyers of the sale of the item, thereby increasing the chances of selling the item. For example, the sponsor may advertise the item on a website, such as a retailer's website.

In some examples, the advertisement may be part of an advertising campaign that identifies one or more products to promote on the website. Each advertising campaign may be established to reach a target audience determined based on several factors such as demographics, interests, and shopping behavior etc. It is valuable to predict an amount of advertising opportunity for a given campaign in a future time period. Existing prediction models face significant challenges in accurate long-term forecasting for new and cold advertising opportunity data, which are characterized by a lack of historical data, new audience provided by advertiser or sudden changes in consumer behavior. This can lead to inaccurate forecasts and inefficient advertising campaigns. Various methods proposed to address this challenge are based on temporal data and require at least a few days of historical advertising opportunity data, which limits their effectiveness.

### SUMMARY

The embodiments described herein are directed to systems and methods for augmenting time series data.

In various embodiments, a system including a database storing current time series data associated with a plurality of users, a computing device comprising at least one processor in communication with the database, the computing device being configured to obtain, from the database, the current time series data, wherein the current time series data is associated with a current time period, generate synthetic historical time series data based on the current time series data, and combine the current time series data and the synthetic historical time series data to generate augmented time series data.

In some embodiments, the computing device is further configured to: identify a start date associated with the current time series data, the start date occurring in the current time period, identify similar time series data in the current time period, the similar time series data being similar to the current time series data and including historical time series data, obtain, from the database, the similar time series data, generate the synthetic historical time series data associated with the current time series data based on the similar time series data, and combine the synthetic historical time series data with the current time series data to generate augmented similar time series data, the combining occurring at the start date such that the synthetic historical time series data predates the start date.

In some embodiments, the similar time series data is identified using Pearson correlation.

In some embodiments, the computing device is further configured to: identify user data associated with the plurality of users and the current time series data, the user data including first user data and second user data, the current time series data includes first time series data associated with a first time series and second time series data associated with a second time series, map the first user data to the first time series data and the second user data to the second time series data, the first user data is associated with a first user and the second user data is associated with a second user different than the first user, determine that the first user data is substantially similar to the second user data, group the first time series data with the second time series data based on the determination that the first user data is substantially similar to the second user data to generate audience time series data, generate the synthetic historical time series data based on the audience time series data, and combine the synthetic historical time series data with the audience time series data to generate augmented audience time series data.

In some embodiments, the first user data is mapped to the first time series data and the second user data is mapped to the second time series data using cookie impression mapping.

In some embodiments, the first user data is mapped to the first time series data and the second user data is mapped to the second time series data using one or more of cookie luid mapping and audience luid mapping.

In some embodiments, the computing device is further configured to train a machine learning model using the augmented time series data. The computing device is further configured to generate, using the second machine learning algorithm, a prediction of advertisement impressions based on the augmented time series data.

In some embodiments, the current time series data does not include historical data.

In some embodiments, the current time series data includes irrelevant historical data.

In some embodiments, the current time series data is associated with a single current time series.

In some embodiments, the synthetic historical time series data includes synthetic historical time series data associated with a historical time period occurring prior to the current time period.

In some embodiments, the computing device is further configured to identify similar time series data, the similar time series data being substantially similar to one or more of the current time series data and user data associated with the current time series date, analyze the similar time series data to determine one or more patterns, and generate the synthetic historical time series data based on the one or more patterns.

In various embodiments, a computer-implemented method is disclosed. The computer-implemented method includes storing, in a database, current time series data associated with a plurality of users, receiving, from the database, the current time series data, wherein the current time series data is associated with a current time period, generating synthetic historical time series data based on the current time series data, and combining the current time series data and the synthetic historical time series data to generate augmented time series data.

In some embodiments, the method further includes identifying similar time series data in the current time period, the similar time series data being similar to the current time series data and including historical time series data, receiving, from the database, the similar time series data, generating the synthetic historical time series data associated with the current time series data based on the similar time series data, and combining the synthetic historical time series data with the current time series data to generate augmented similar time series data.

In some embodiments, the method further includes identifying user data associated with the plurality of users and the current time series data, the user data including first user data and second user data, the current time series data includes first time series data associated with a first time series and second time series data associated with a second time series, mapping the first user data to the first time series data and the second user data to the second time series data, the first user data is associated with a first user and the second user data is associated with a second user different than the first user, determining that the first user data is substantially similar to the second user data, grouping the first time series data with the second time series data based on the determination that the first user data is substantially similar to the second user data to generate audience time series data, generating the synthetic historical time series data based on the audience time series data, and combining the synthetic historical time series data with the audience time series data to generate augmented audience time series data.

In some embodiments, the first user data is mapped to the first time series data and the second user data is mapped to the second time series data using one or more of cookie impression mapping, cookie luid mapping, and audience luid mapping.

In some embodiments, the method further includes identifying similar time series data, the similar time series data being substantially similar to one or more of the current time series data and user data associated with the current time series date, analyzing the similar time series data to determine one or more patterns, and generating the synthetic historical time series data based on the one or more patterns.

In some embodiments, the synthetic historical time series data includes synthetic historical time series data associated with a historical time period occurring prior to the current time period.

In various embodiments, a non-transitory computer readable medium having instructions stored thereon is disclosed. The instructions, when executed by at least one processor, cause at least one device to perform operations including: storing, in a database, current time series data associated with a plurality of users, receiving, from the database, the current time series data, wherein the current time series data is associated with a current time period, generating synthetic historical time series data based on the current time series data, combining the current time series data and the synthetic historical time series data to generate augmented time series data.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to predict advertising opportunity for advertising campaigns, in accordance with some embodiments of the present teaching.

FIG. 2 is a block diagram of a time series augmenter, in accordance with some embodiments of the present teaching.

FIG. 3 is a block diagram illustrating various portions of a system for generating synthetic time series data to augment current time series data, in accordance with some embodiments of the present teaching.

FIG. 4A illustrates a current time series representing a new time series absent historical data, in accordance with some embodiments of the present teaching.

FIG. 4B illustrates a current time series representing a phase changing time series with irrelevant historical data, in accordance with some embodiments of the present teaching.

FIG. 5 illustrates a plurality of similar time series having historical data, in accordance with some embodiments of the present teaching.

FIG. 6 illustrates a synthetic time series that has been generated based on augmentation of a current time series and the plurality of similar time series of FIG. 5, in accordance with some embodiments of the present teaching.

FIG. 7A illustrates a plurality of cold current time series associated with a plurality of users, in accordance with some embodiments of the present teaching.

FIG. 7B illustrates a plurality of audience time series that has been generated based a plurality of user time series, in accordance with some embodiments of the present teaching.

FIG. 8 illustrates a synthetic time series that has been generated based on augmentation of the cold current time series, in accordance with some embodiments of the present teaching.

FIG. 9 is a flowchart illustrating an exemplary method for generating synthetic time series data to augment current time series data, in accordance with some embodiments of the present teaching.

FIG. 10 is a flowchart illustrating an exemplary method for generating synthetic time series data to augment current time series data, in accordance with some embodiments of the present teaching.

FIG. 11 is a flowchart illustrating an exemplary method for generating synthetic time series data to augment current time series data using similar time series data, in accordance with some embodiments of the present teaching.

FIG. 12 is a flowchart illustrating an exemplary method for generating synthetic time series data to augment current time series data using similar audience time series data, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

An online marketplace or retailer may provide advertising opportunities to online sellers who want to promote their products, e.g. when a user submits a query, clicks on an item, or adds an item to cart online. Since the amount of advertising opportunities for a given advertising campaign would change with time, a time series data can be used to represent the advertising opportunities for each advertising campaign. While the retailer can provide an advertising platform allowing advertisers to manage their campaigns directly on the retailer's website, forecasting future advertising opportunities plays a key role as it helps advertisers to plan and allocate their budgets more effectively based on the forecasted time series of advertising opportunities.

One goal of the present teaching is to forecast advertising opportunities for new, short, phase changing and/or cold time-series lacking historical data or having irrelevant data. In some embodiments, a disclosed system utilizes augmentation of existing or current time series data. The system can find similar one or more time-series and generate historical time series data for new and cold time-series data based on the current time series data, without requiring temporal data or any amount of historical data. The disclosed augmentation method can significantly enhance the effectiveness of advertising campaigns by providing more accurate forecast for new, short, phase changing and/or cold time-series.

In some embodiments, the disclosed system is directed to augmenting historical data of a time series. The disclosed system may generate a synthetic time series based on a current time series and similar time series. For example, the disclosed system may use a predictive model to generate synthetic time series data associated with the current time series data. The current time series may have no or minimal historical data. In some embodiments, the current time series has irrelevant historical data. The irrelevant historical data may be historical data that is incomplete or erroneous. In some embodiments, the current time series is a cold time series that does not have any historical data. The disclosed system may generate a synthetic audience time series based on a plurality of current time series each associated with a user. Similar users may be grouped together to generate a synthetic audience time series, which may be used augment the current time series. The current time series may be associated with a single user or a plurality of users. For example, the current time series may be a cold time series associated with a single user and plurality of current time series may be used to generate a synthetic audience time series. In some embodiments, time series data refers to data associated a time series. For example, current time series data may refer to data associated with a current time series and synthetic historical time series data may refer to data associated with a synthetic historical time series.

The system can train a predictive model (e.g., machine learning model) to generate synthetic time series data The predictive model may be configured to generate synthetic historical data, which may be combined with the current time series data to generate an augmented time series having historical data.

In some embodiments, the output of the predictive model (e.g., the synthetic historical data) is combined with the current time series data (to generate augmented time series data) and is inputted into a forecasting predictive model. The forecasting predictive model (e.g., a second machine learning model) may be configured to analyze the augmented time series data to generate predictive advertising opportunity data. The predictive advertising opportunity data may be used to predict peaks in advertisement opportunities or impressions. For a cold advertising campaign with no historical time-series data, the predictive model can be used to generate an audience time series based on the current time series and similar users.

In various embodiments, the predicted advertising opportunity data may be used to estimate: supply forecast representing a total forecasted supply present in an advertisement opportunity inventory for a particular time period, auction opportunity which indicates advertisement impressions buyers can buy through auction or competition, and/or winning impression which indicates an amount of impressions a buyer can win with a particular bid value in the environment of auction opportunity. The disclosed methods can increase coverage and reliability of advertising opportunity forecast. This will improve predictability of advertising performance, help advertisers in campaign planning, increase engagement of advertisers, and increase advertising revenue of the retailer.

Furthermore, in the following, various embodiments are described with respect to methods and systems for augmenting time series data based on generation of synthetic historical data are disclosed. In some embodiments, a disclosed method includes: storing, in a database, current time series data associated with a plurality of users, receiving, from the database, the current time series data, wherein the current time series data is associated with a current time period, generating synthetic time series data based on the current time series data, and combining the current time series data and the synthetic time series data to generate augmented time series data.

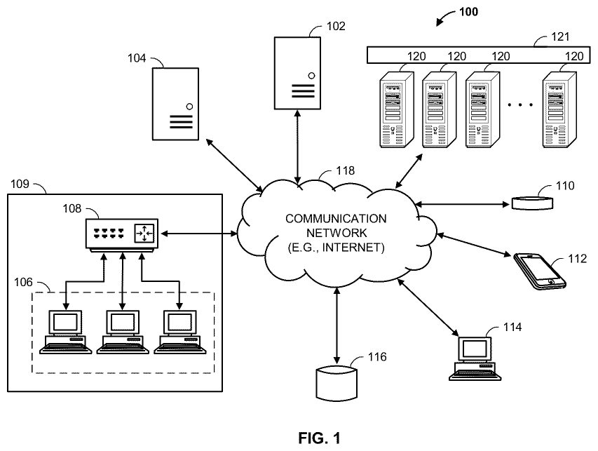

Turning to the drawings, FIG. 1 is a network environment 100 configured to augment time series data, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a time series augmenter 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The time series augmenter 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the time series augmenter 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the time series augmenter 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the time series augmenter 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the time series augmenter 102 over the communication network 118. The workstation(s) 106 may send data to, and receive data from, the time series augmenter 102. For example, the workstation(s) 106 may transmit data identifying items purchased by a customer at the store 109 to the time series augmenter 102.

Although FIG. 1 illustrates three user computing devices 110, 112, 114, the network environment 100 can include any number of user computing devices 110, 112, 114. Similarly, the network environment 100 can include any number of the time series augmenter 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and transmit the user session data to the time series augmenter 102 over the communication network 118. The website may also allow the customer to add one or more of the items to an online shopping cart, and allow the customer to perform a “checkout” of the shopping cart to purchase the items. In some examples, the web server 104 transmits purchase data identifying items the customer has purchased from the website to the time series augmenter 102.

In some examples, an advertiser or a sponsor of advertisement, e.g., an online seller, may operate one of the user computing devices 110, 112, 114 to initiate a web browser or a user interface that is associated with a website hosted by the web server 104. The advertiser may, via the web browser or the user interface, view item sets sold by the seller on the website, view and manage existing campaigns for some item sets sold by the seller, view items recommended by the retailer based on machine learning models to create new campaigns for upcoming events, and/or create a new campaign including an item set sold by the seller. The website may capture at least some of these activities as campaign data. The web server 104 may transmit the campaign data to the time series augmenter 102 over the communication network 118, and/or store the campaign data to the database 116.

In some embodiments, the web server 104 transmits an augmenting request to the time series augmenter 102, e.g. upon a selection of an advertiser to create or run an advertising campaign. For example, the augmenting request may be sent based on the desire of an advertiser to have forecasting data. Without augmentation of the time series data, the forecasting data may be unobtainable for a current time series (e.g., a new, short, phase-changing, or cold time series). The augmenting request may be sent standalone or together with campaign related data of the website. In some examples, the augmenting request may carry or indicate campaign data of a proposed campaign, e.g. a targeting criteria set associated with the campaign.

In some examples, the time series augmenter 102 may execute one or more models (e.g., algorithms), such as a machine learning model, deep learning model, statistical model, etc., to predict advertising opportunity for an advertising campaign. The time series augmenter 102 may generate synthetic historical data for the current time series associated with the advertising campaign, based on a trained machine learning model. The synthetic historical data may be combined with the current time series data to generate augmented time series data. The augmented time series data may be inputted into another model (e.g., a second model or forecasting model) configured to output predictive advertising opportunity data. In some embodiments, the time series augmenter 102 executes the forecasting model. The time series augmenter 102 may transmit the predicted advertising opportunity data to provide a forecast for the advertising campaign in a predetermined time period.

The time series augmenter 102 is further operable to communicate with the database 116 over the communication network 118. For example, the time series augmenter 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the time series augmenter 102, in some examples, the database 116 can be a local storage device, such as a hard drive, a non-volatile memory, or a USB stick. The time series augmenter 102 may store online purchase data received from the web server 104 in the database 116. The time series augmenter 102 may receive in-store purchase data from different stores 109 and store them in the database 116. The time series augmenter 102 may also receive from the web server 104 user session data identifying events associated with browsing sessions, and may store the user session data in the database 116. The time series augmenter 102 may also determine advertising opportunity data for campaigns, and may store advertising opportunity data in the database 116. In some embodiments, database 116 stores the current time series data and historical data associated with similar time series data. Database 116 may be coupled to a computing device.

In some embodiments, the web server 104 transmits a model training request to the time series augmenter 102, e.g. upon an event or holiday, an instruction from a manager, or upon a pre-configured periodic prediction job. Upon the model training request, the time series augmenter 102 may retrieve, e.g. from the database 116, current time series data associated with some campaigns. The time series augmenter 102 can determine whether the current time series is a non-cold campaign having a small amount or an irrelevant amount of historical data or a cold campaigns having no historical data. For each non-cold campaign, historical data can be generated (e.g., synthetic historical data) and combined with the current time series data to generate augmented time series data. The time series augmenter 102 may retrieve from database 116 similar time series data. In some embodiments, time series augmenter 102 identifies time series that are similar to current time series based on analysis of each time series stored within database 116. For example, time series augmenter 102 may analyze the current time series data and the data of each time series stored in database 116 and identify one or more time series that are similar to the current time series data. A time series (e.g., time series data) may be similar to a current time series (e.g., current time series data) based on substantially similar waveforms (e.g., peaks and valleys). In some embodiments, time series augmenter 102 is configured to determine which time series are similar to the current time series by analyzing the time series data associated with each similar time series and comparing it to the current time series data. Time series augmenter 102 may generate a comparison value based on the comparison and based on a predetermined threshold, may determine whether the time series associated with the identified time series data is substantially similar.

An advertising campaign may change its targeting criteria when there is a change in advertising location, page type, etc. for the advertising campaign. The changed targeting criteria corresponds to a newly generated targeting query with no or sparse historical data. In addition, advertising frequently comes with new audience list having no historical data. Instead of relying on any historical data, the trained model can be used to generate synthetic historical data to generate augmented time series having historical data to allow for better forecasting and predictions of advertising opportunities for advertising campaigns.

For each retrieved cold campaign, the time series augmenter 102 can identify a cold time series associated with a targeted user. Time series augmenter 102 may execute a trained model to identify a plurality of users that are similar to the targeted user and group the similar users to generate an audience time series. The audience time series may be inputted into a trained model to generate an augmented time series associated with the cold time series that includes historical data.

In some examples, the time series augmenter 102 generates training data for a plurality of models (e.g., machine learning models, deep learning models, statistical models, algorithms, etc.) in addition to the forecasting model. The training data may be prior time series that have been augmented. The time series augmenter 102 trains the models based on their corresponding training data, and stores the models in a database, such as in the database 116 (e.g., a cloud storage).

The models, when executed by the time series augmenter 102, allow the time series augmenter 102 to generate augmented time series data and/or determine predicted advertising opportunity data for advertising campaigns. In some examples, the time series augmenter 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the time series augmenter 102 may generate augmented time series data and/or predicted advertising opportunity data for advertising campaigns.

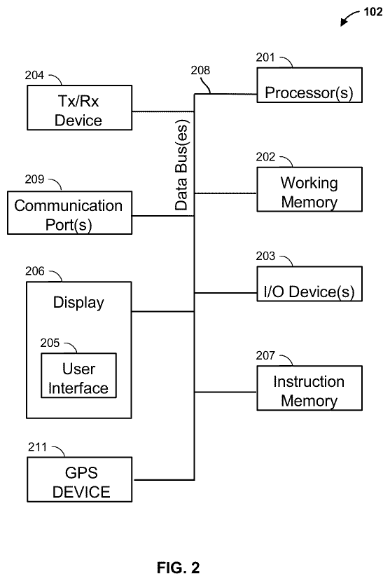

FIG. 2 illustrates a block diagram of a time series augmenter, e.g. the time series augmenter 102 of FIG. 1, in accordance with some embodiments of the present teaching. In some embodiments, each of the time series augmenter 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the time series augmenter 102 can be combined, omitted, and/or replicated. In addition, it will be appreciated that additional elements other than those illustrated in FIG. 2 can be added to the time series augmenter 102.

As shown in FIG. 2, the time series augmenter 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the time series augmenter 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the time series augmenter 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the time series augmenter 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the time series augmenter 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the time series augmenter 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the time series augmenter 102 and/or the web server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the time series augmenter 102 may determine a local geographical area (e.g., town, city, state, etc.) of its position.

In some embodiments, the time series augmenter 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

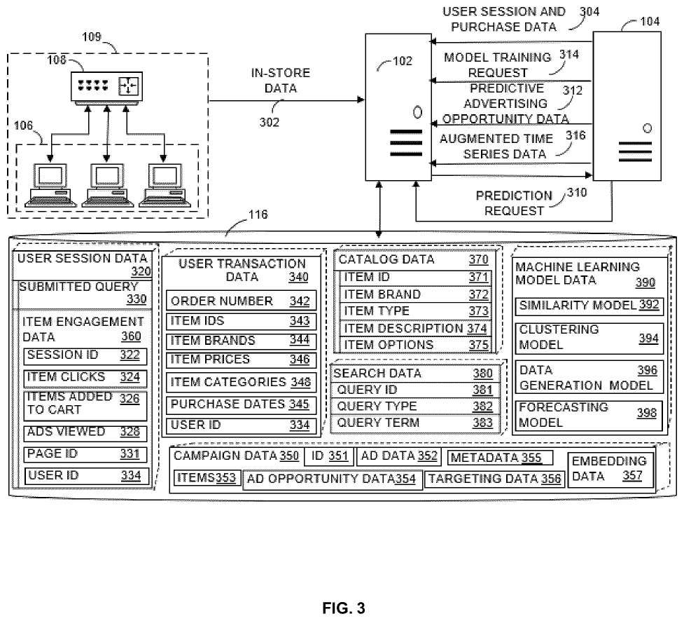

FIG. 3 is a block diagram illustrating various portions of a system for generating synthetic time series data to augment current time series data, e.g. the system shown in the network environment 100 of FIG. 1, in accordance with some embodiments of the present teaching. As indicated in FIG. 3, the time series augmenter 102 may receive user session and purchase data 304 from the web server 104. The user session and purchase data 304 may include user session data 320 identifying, for each user (e.g., customer), data related to that user's browsing session, such as when browsing a retailer's webpage hosted by the web server 104. The time series augmenter 102 may store the user session data 320 into the database 116.

In some examples, the user session data 320 may include item engagement data 360 and/or submitted query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed and/or clicked during the browsing session, page ID 331 identifying a webpage (product page, search result page, home page, etc.) the user engaged with, and user ID 334 (e.g., a customer ID, retailer website login ID, a cookie ID, etc.). The submitted query data 330 may identify one or more searches conducted by a user during a browsing session (e.g., a current browsing session).

The user session and purchase data 304 may also identify and characterize one or more online purchases, such as purchases made by the user and other users via a retailer's website hosted by the web server 104. The time series augmenter 102 may also receive in-store data 302 from the store 109, which identifies and characterizes one or more in-store purchases, in-store advertisements, in-store shopping data, etc. In some embodiments, the in-store data 302 may also indicate availability of items in the store 109, and/or user IDs that have selected the store 109 as a default store for picking up online orders.

The time series augmenter 102 may parse the in-store data 302 and the user session and purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a category of each item purchased, a purchase date 345 identifying the purchase date of the purchase order, and user ID 334 for the user making the corresponding purchase.

The database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., a product type like grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store search data 380, which may identify one or more attributes of a plurality of queries submitted by users on the website hosted by the web server 104 and/or on a website of a search engine hosted by the search engine server 190. The search data 380 may include, for each of the plurality of queries, a query ID 381 identifying a query previously submitted by users, a query type 382 (e.g., a head query, a torso query, or a tail query), and query term 383 identifying terms in a query.

In some embodiments, the database 116 may further store campaign data 350, which may identify data of one or more advertising campaigns proposed and/or created for the retailer's website hosted by the web server 104. The campaign data 350 may identify, for each campaign, campaign ID 351 identifying the campaign, advertisement data 352 identifying advertisements included in the campaign, campaign items 353 identifying items promoted by the campaign, advertising opportunity data 354 identifying historical and predicted advertising opportunities for campaigns, metadata 355 identifying meta information associated with each campaign, targeting data 356 identifying targeting criteria for each campaign, and embedding data 357 identifying embeddings mapped from campaign metadata. In some examples, metadata 355 may include a set of attributes associated with a campaign, e.g. advertising unit in a web page, advertising location in a web page, web page type, target audience, etc.

The database 116 may also store machine learning model data 390 identifying and characterizing one or more machine learning models and related data for predicting advertising opportunity. For example, the machine learning model data 390 may include a similarity model 392, a grouping model 394, a data generation model 396, and a forecasting model 398.

In some embodiments, the similarity model 392 is used to determine a similarity score between one or more time series data, each representing advertising opportunity data over a same time period for a respective campaign. The similarity model 392 may be trained based on one or more of the following metrics: correlation, L1 norm, L2 norm, dynamic time warping metric, etc. For example, the similarity model 392 may be used to generate a similarity matrix, each element of which is a similarity score for a corresponding pair of two time-series data. The similarity matrix includes all similarity scores for all possible pairs of time-series data being concerned.

In some embodiments, similarity model 392 is configured to find users similar to a user associated with a current time series. For example, similarity model 392 may determine a similarity score between a plurality of users and may determine one or more users similar to the user associated with the current time series.

The clustering model 394 may be used to group all time-series data being concerned into a plurality of clusters, based on the similarity matrix. Each time-series data represents advertising opportunity data for a campaign, and may be associated in groups with similar time series. In some embodiments, the clustering model 394 may be trained or generated based on agglomerative clustering using average linkage or maximum linkage. In some embodiments, clustering model 394 groups all similar users in a cluster, the similar users being similar to the user associated with the current time series. For example, the current time series may be associated with a single user and similarity model 392 may be configured to determine and identify time series associated with users similar to the single user. Clustering model 394 may be configured to group similar users and/or each time series associated with the similar users.

The data generation model 396 may be used to generate synthetic data (e.g., historical data). Data generation model 396 may be a model (e.g., algorithm), such as a machine learning model, deep learning model, statistical model, etc. Data generation model 396 may be configured to generate synthetic data for a current time series based on one or more time series similar to the current time series. For example, similarity model 392 may be used to identify time series similar to the current time series and data generation model 396 may generate synthetic data (e.g., historical data) associated with the current time series based on the similar time series.

In some embodiments, data generation model 396 generates audience time series. For example, data generation model 396 may receive time series data associated with similar users that are similar to the user associated with a time series (e.g., a current time series). Data generation model 396 may generate an audience time series by grouping/aggregating the all the time series associated with the similar users. Data generation model 396 may generate synthetic data (e.g., historical data) associated with the current time series based on the audience time series.

In some embodiments, time series augmenter 102 combines the synthetic data (e.g., historical data) with the current time series generated by data generation model 396 to create an augmented time series (e.g., augmented time series data 316).

In some embodiments, forecasting model 398 is configured to generate predictive advertising opportunity data based on the augmented time series data 316. For example, the augmented time series data 316 may be inputted into forecasting model 398 and forecasting model 398 may determine patterns of highs and lows to generate predictive advertising opportunity data. Predictive advertising opportunity data may be used to forecast increases or decreases in advertising opportunities.

In some examples, the time series augmenter 102 receives (e.g., in real-time) from the web server 104, a prediction request 310 seeking advertising opportunity information in a future time period for an advertising campaign. In response, the time series augmenter 102 can generate predictive advertising opportunity data 312 for the advertising campaign based on the augmented time series data 316. The predictive advertising opportunity data 312 may be transmitted by the time series augmenter 102 to the web server 104, to be shown to a corresponding seller proposing or creating the campaign.

In some examples, the time series augmenter 102 receives from the web server 104, a model training request 314 for training one or more models for generation of an augmented time series and/or an advertising opportunity forecast. In response, the time series augmenter 102 can retrieve time-series data from the database 116 to generate training data. The training data may be used to train the one or more of data generation model 396 and forecasting model 398 based on a neural network. In some embodiments, the time series augmenter 102 itself may periodically train the models in the machine learning model data 390 without any request from the web server 104.

In some embodiments, the time series augmenter 102 may assign one or more of the operations described above to a different processing unit or virtual machine hosted by the one or more processing devices 120. Further, the time series augmenter 102 may obtain the outputs of the these assigned operations from the processing units, to train the machine learning models or generate the predictive advertising opportunity data 312 based on the outputs.

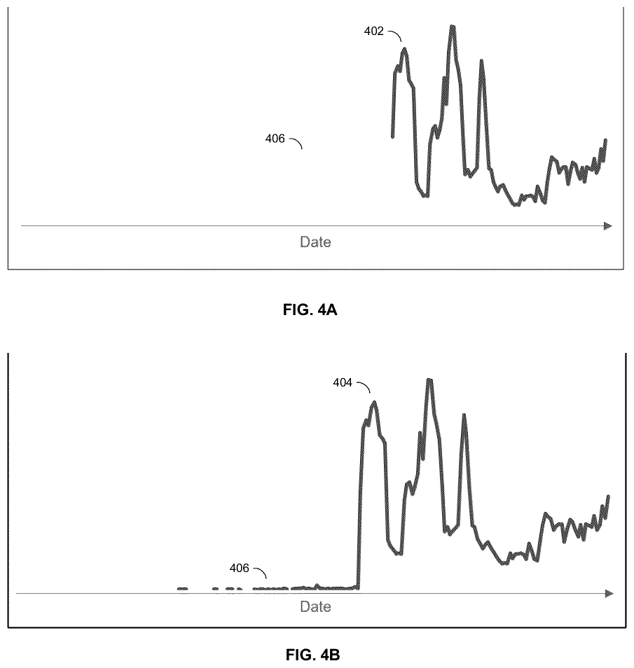

FIGS. 4A and 4B illustrate current time series data. Each data point on the time-series data 402 and 404 may represent a daily traffic from a target audience associated with the advertising campaign, thereby indicating a daily advertising opportunity for the advertising campaign and indicating a daily magnitude of advertising opportunity inventory for the target audience.

FIG. 4A is an illustration of the current time series being short time series 402. Short time series 402 may include incomplete or minimal historical data 406. As illustrated in FIG. 4A, short time series 402 has absent or minimal historical data 406. In some embodiments, database 116 stores data associated with short time series 402. Time series augmenter 102 may be configured to retrieve from database 116 data associated with short time series 402. The data associated with short time series 402 may include minimal historical data. In some embodiments, upon retrieving data associated with short time series 402, time series augmenter 102 generates synthetic historical data. In some embodiments, the data associated with short time series 402 (e.g., short time series data) includes minimal data prior to a specific date. In some embodiments, historical data 406 is data prior to the specific date.

FIG. 4B is an illustration of the current time series being phase-changing time series 404. Phase-changing time series 404 may include incomplete or minimal historical data 406. As illustrated in FIG. 4B, phase-changing time series 404 has irrelevant and minimal historical data 406. Irrelevant historical data 406 may include historical data that is incomplete or erroneous. In some embodiments, database 116 stores data associated with phase-changing time series 404. Time series augmenter 102 may be configured to retrieve from database 116 data associated with phase-changing time series 404. The data associated with phase-changing time series 404 may include minimal historical data. In some embodiments, upon retrieving data associated with phase-changing time series 404, time series augmenter 102 generates synthetic historical data. In some embodiments, the data associated with phase-changing time series 404 (e.g., phase-changing time series data) includes irrelevant (e.g., incomplete or erroneous) data prior to the specific date.

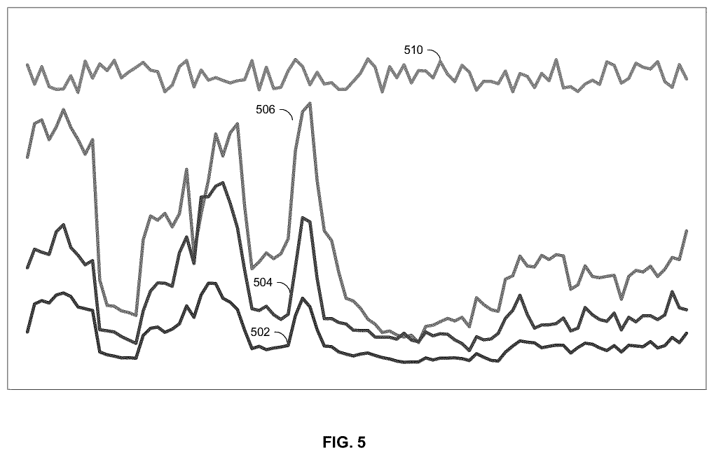

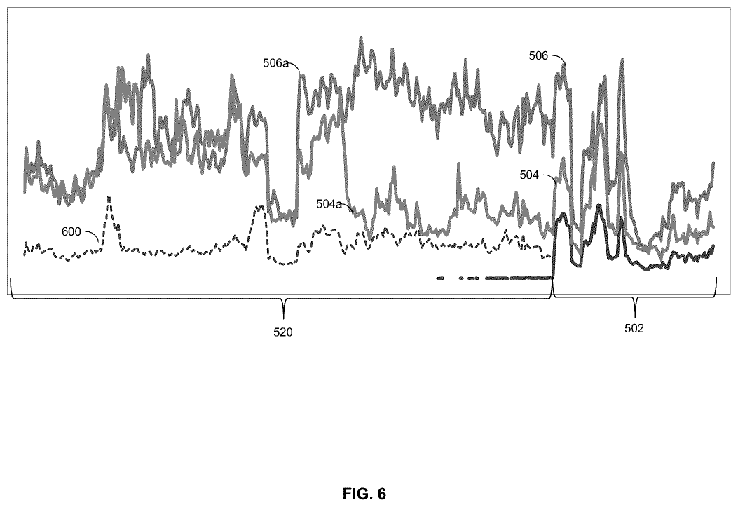

FIG. 5 is an illustration of a plurality of time series including the current time series 502, a plurality of similar time series 504,506, and a non-similar time series 510. As discussed above, time series augmenter 102 may be configured to determine or identify (e.g., via similarity model 392) one or more time series similar to current time series 502. For example, time series augmenter 102 may be configured to retrieve or obtain from database 116 time series data that is similar to current time series data. In some embodiments, non-similar time series data, such as time series data associated with non-similar time series 510, is identified along with similar time series data (e.g., similar time series data associated with similar time series 504, 506). In some embodiments, time series augmenter 102 determines and identifies similar time series based on determine a pattern of current time series 502 and identifying time series with a substantially similar pattern.

In some embodiments, time series augmenter 102 is configured to filter out non-similar time series (e.g., non-similar time series 510). For example, time series augmenter 102 may be configured to compare time series data (e.g., representing a plurality of time series) stored in database 116 to current time series 502 to generate a comparison (e.g., similarity score). Time series augmenter 102 may compare the comparison (e.g., similarity score) to a predetermined threshold such that time series that are below the predetermined threshold are deemed non-similar to current time series 502. In some embodiments, time series augmenter 102 may compare the comparison (e.g., similarity score) to the predetermined threshold such that time series that are above the predetermined threshold are deemed non-similar to current time series 502.

In some embodiments, as discussed below, similar time series 504, 506 includes historical data. Historical data may be data predating a specific date. For example, similar time series 504, 506 may include data predating the specific data, whereas current time series 502 includes minimal or irrelevant data predating the specific date.

FIG. 6 is an illustration of similar time series 506, 504 and current time series 502. Similar time series 504 may include historical data 504a and similar time series 506 may include historical data 506a. Time series augmenter 102 may generate synthetic historical data 520 for current time series 502. In some embodiments, time series augmenter 102 uses, for example, data generation model 396 to generate synthetic historical data 520. Time series augmenter 102 may generate synthetic data 520 based on historical data 504a and/or historical data 506a. For example, time series augmenter 102 may identify similar time series 504 having historical data 504a and similar time series 506 having historical data 506a, each being similar to current time series 502. Time series augmenter 102 may analyze historical data 504a and historical data 506a to determine one or more patterns and generate synthetic historical data 520. Current time series 502 may have minimal or irrelevant historical data predating a specific date and time series augmenter 102 may generate a synthetic time series (e.g., synthetic historical data 520) predating the specific date.

In some embodiments, time series augmenter 102 combines the generated synthetic time series 520 (e.g., synthetic historical data 520) and current time series 502 to generate augmented time series 600. For example, time series augmenter 102 may combine current time series 502 and synthetic time series 520 at the specific date to generate augmented time series 600. For example, current time series 502 may comprise augmented time series 600 after the specific date and synthetic time series 520 may comprise augmented time series 600 predating the specific date. In other words, synthetic time series 520 and current time series 502 may be combined or joined at the specific date.

In some embodiments, time series augmenter 102 is configured to use one or more models (e.g., machine models) to generate synthetic time series 520 (e.g., synthetic historical data). Time series augmenter 102 may train one or more models using historical time series data. For example, time series augmenter 102 may train a model (e.g., data generation model 396) using historical time series data that include historical data. In some embodiments, time series augmenter 102 generates, based on training date (e.g., historical time series data), synthetic historical data for a historical time series already having real historical data and may compare the synthetic historical data to the real historical data. Time series augmenter 102 may refine the model based on the comparison to improve the accuracy of the model.

In some embodiments, current time series 502 and similar time series 506, 504 are inputted into a model. Current time series 502 may be a dependent variable and similar time series 506, 504 may each be independent variables.

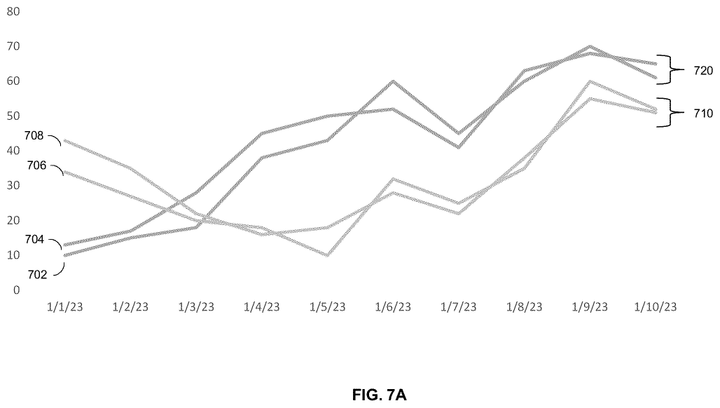

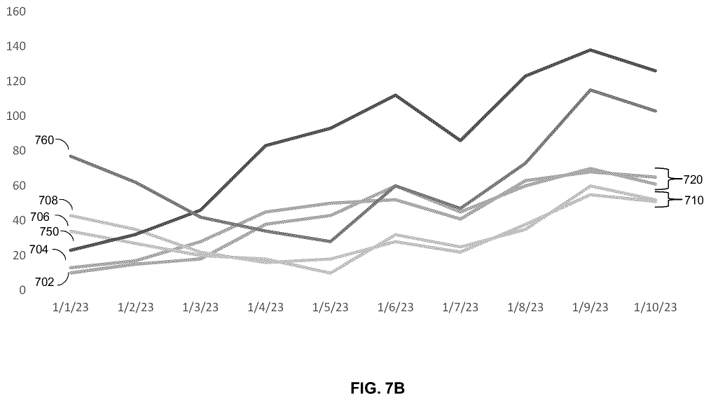

FIG. 7A is an illustration of a plurality of user time series 702, 704, 706, and 708. In some embodiments, a current time series is a cold time series having no historical data. Time series augmenter 102 may be configured to determine a plurality of users associated with the current time series and identify user time series 702, 704, 706, and 708 each associated with a user of the plurality of users associated with the current time series.

In some embodiments, each of user time series 702, 704, 706, and 708 is a time series associated with a different user. Time series augmenter 102 may be configured to tag similar users. For example, time series augmenter 102 may be configured to group time series that are associated with similar users. In some embodiments, time series augmenter 102 is configured to analyze the time series of each user associated with advertising campaign (e.g., users who have interaction with the advertising campaign). Time series augmenter 102 may group or cluster together individual time series of users that have similar data or interactions.

In some embodiments, time series augmenter 102 compares time series data of each user to one another to determine which users have time series that are similar to each other. Time series augmenter 102 may group similar users based on their time series. For example, time series augmenter 102 may analyze the patterns of each time series associated with each user and determine which user time series are similar. Time series augmenter 102 may group similar user time series.

With reference to FIG. 7A, time series augmenter 102 may be configured to group or aggregate user time series 702 and user time series 704 together due to the user associated with user time series 702 being similar (e.g., based interactions or activity of the user) to the user associated with user time series 704. Time series augmenter 102 may also be configured to group or aggregate user time series 706 and user time series 707 together due to the user associated with user time series 706 being similar (e.g., based interactions or activity of the user) to the user associated with user time series 708. Time series augmenter 102 may then generate user group 710 and user group 720. User group 710 may include user time series 702 and 704 and user group 720 may include user time series 708 and 706.

FIG. 7B is an illustration of a plurality of audience time series. Time series augmenter 102 may be configured to generate audience time series 750 and 760. In some embodiments, time series augmenter 102 is configured to generate audience time series 750 and 760 based on user time series 702, 704, 706, and 708. For example, time series augmenter 102 may be configured to generate audience time series 750 based on user group 710 (e.g., user time series 702 and 704) and may be configured to generate audience time series 760 based on user group 720 (e.g., user time series 706 and 708). Each of audience time series 750 and 760 is associated with a plurality of similar users. The plurality of similar users of audience time series 750 may be different than the plurality of similar users of audience time series 760. In some embodiments, time series augmenter 102 is configured to aggregate data associated with group 710 (e.g., user time series 702 and 704) to generate audience time series 750 and is configured to aggregate data associated with group 720 (e.g., user time series 706 and 708) to generate audience time series 760.

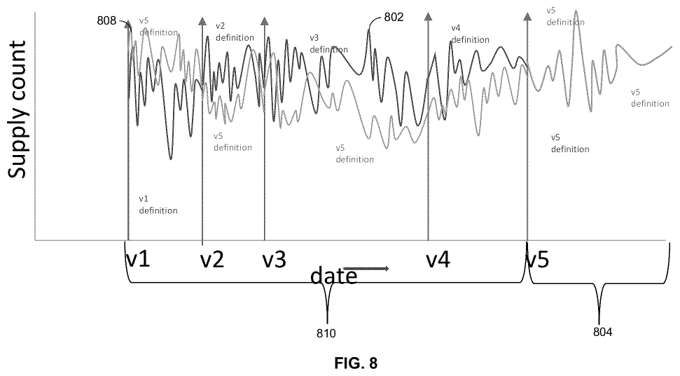

FIG. 8 is an illustration of augmented cold time series 808. In some embodiments, time series augmenter 102 generates audience time series (e.g., audience time series 802) as discussed above. Time series augmenter 102 may be configured to augment current time series 804 based on an audience time series (e.g., audience time series 802). For example, time series augmenter 102 may be configured to augment current time series 804, which may be a cold time series.

In some embodiments, time series augmenter 102 is configured to generate synthetic historical data 810 based on audience time series 802. For example, current time series 804 may not include historical data and time series augmenter 102 may input audience time series 802 into one or more trained models to generate synthetic historical data 810. Augmented cold time series 808 may be generated based on combining synthetic historical data 810 and current time series 804. In some embodiments, augmented cold time series 808 is inputted into a forecasting predictive model configured to analyze augmented cold time series data 808 to generate predictive advertising opportunity data.

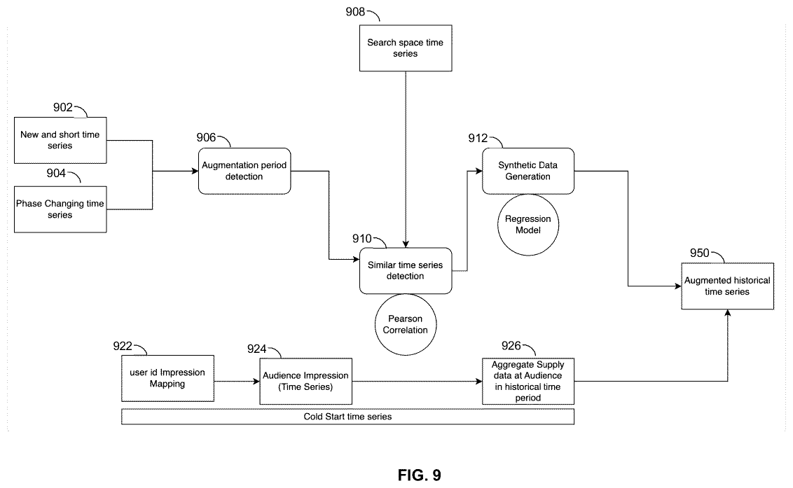

FIG. 9 is a flowchart illustrating an exemplary method for generating synthetic time series data to augment current time series data. At operation 902 and operation 904, time series augmenter 102 determines whether the current time series is a new and short time series or a phase changing time series. For short time series, the augmentation period starts right before the start of the time series. For phase change time series, shift detection techniques are used to determine the augmentation period.

Time series augmenter 102 may determine the type of current time series by analyzing the historical data and/or historical portion associated with the current time series. At operation 906, time series augmenter 102 detects the presence of a historical data and proceed with augmenting the current time series upon determining if there is minimal or irrelevant historical data associated with the current time series.

At operation 908, time series augmenter 102 searches database 116 for time series data that is similar to the current time series. At operation 910, time series augmenter 102 identifies similar time series to current time series. In some embodiments, Pearson correlation coefficient is used to detect similar time series in recent time. The Pearson correlation coefficient is computed based on:

$$r = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

In some embodiments, a high cut-off value or threshold is set based on the desired requirements. For example, a high cut-off value or threshold may be used to include only very similar time series and less non-similar time series whereas a low cut-off value or threshold may be used to allow some non-similar time series. In some embodiments, similar metrics may be to detect or identify similar time series. For example, other similarity metrics like Euclidean distance, correlation, L1 norm, L2 norm, dynamic time warping metric, etc., can also be used.

At operation 912, synthetic historical data may be generated by time series augmenter 102. For example, time series augmenter 102 may use one or more models to generate synthetic historical data based on the current time series and similar time series. In some embodiments, a regression model is fitted on the identified similar time series. The regression model may be:

$$Y = a + {b}_{1} {X}_{1} + {b}_{2} {X}_{2} + {b}_{3} {X}_{3} + … + ε$$

In some embodiments, the regression model is used to generate synthetic historical data associated with the current time series. Other predictive models may also be implemented such as machine learning models, tree based regressors, deep learning models, statistical models, algorithms, etc.

At operation 950, augmented time series is generated. For example, time series augmenter 102 may generate augmented time series (e.g., augmented time series data) based on the generated synthetic historical data and the current time series. As discussed above, time series augmenter 102 may combine the generated synthetic historical data and the current time series data to generate augmented time series data. The augmented time series data may be used to generated predictive forecasts of advertising opportunities.

At operation 922, time series augmenter 102 may determine that the current time series is a cold start time series (e.g., a cold time series having no historical data). Operation 922 may include user id impression mapping to determine the users associated with the current time series. In some embodiments, cookie luid mapping and/or cookie impression mapping may be used to determine the users associated with the current time series.

At operation 924, the users are grouped into audiences and an audience time series is generated based on the time series associated with each of the plurality of users. In some embodiments, audience luid mapping is used to group the users into audiences and to generate audience time series. At operation 926, synthetic historical data is generated based on the audience time series data.

At operation 950, augmented time series is generated. For example, time series augmenter 102 may generate augmented time series (e.g., augmented time series data) based on the generated synthetic historical data from operation 926 and the current time series. As discussed above, time series augmenter 102 may combine the generated synthetic historical data and the current time series data to generate augmented cold start time series data. The augmented cold start time series data may be used to generated predictive forecasts of advertising opportunities.

In some embodiments, time series augmenter 102 is configured to use one or more models to generate synthetic historical data and/or forecasting data. Time series augmenter 102 may train the one or more models based on a loss function. For example, time series augmenter 102 may train a model using a training time series with known historical data and use the model to generate synthetic historical data. The synthetic historical data may be compared to the known historical data and a loss function may be generated based on the comparison. Time series augmenter 102 may re-train the model to minimize the loss function such that the synthetic historical data generated for the training time series is substantially similar or identical to the known historical data for the training time series. Time series augmenter 102 may train one or more models using a plurality of training time series. In some embodiments, during use, the output of the one or more models is used to re-train and refine the one or more models.

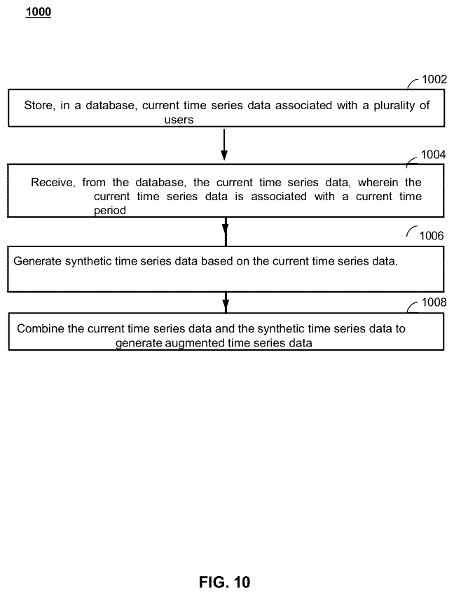

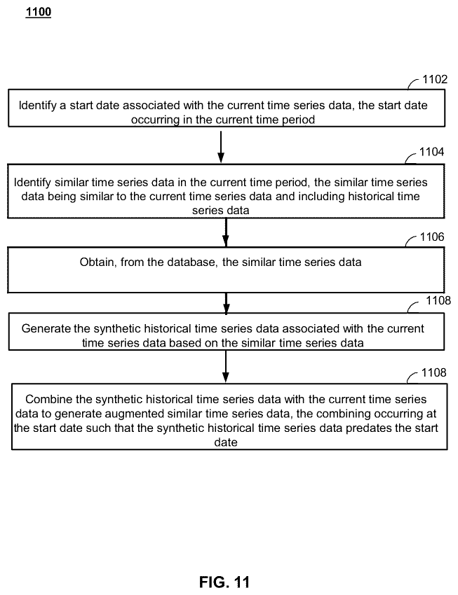

FIG. 10 is a flowchart illustrating an exemplary method 1000 for generating synthetic time series data to augment current time series data, in accordance with some embodiments of the present teaching. In some embodiments, the method 1000 can be carried out by one or more computing devices, such as the time series augmenter 102 of FIG. 1. Beginning at operation 1002, current time series data is stored in a database. The current time series may be associated with a plurality of users. At operation 1004, time series augmenter 102 is configured to receive from the database, the current time series data. The current time series data may be associated with a current time period. At operation 1006, time series augmenter 102 may be configured to generate synthetic time series data (e.g., synthetic historical data) based on the current time series data. At operation 1008, time series augmenter 102 is configured to combine or aggregate the current time series data and the synthetic time series data to generate augmented time series data.

FIG. 11 is a flowchart illustrating an exemplary method 1100 for generating synthetic time series data to augment current time series data, in accordance with some embodiments of the present teaching. In some embodiments, the method 1100 can be carried out by one or more computing devices, such as the time series augmenter 102 of FIG. 1. Beginning at operation 1102, a start date is identified. The start date may be associated with the current time series data and may occur during the current time period. At operation 1104, similar time series data are identified in the current time period. The similar time series data may be similar to the current time series data and may include historical time series data. At operation 1106, the similar time series data may be obtained from the database. At operation 1108, synthetic historical time series data may be generated. At operation 1108, the synthetic historical time series data is combined with the current time series data to generate augmented similar time series data. In some embodiments, the combining occurs at the start date such that the synthetic historical time series data predates the start date.

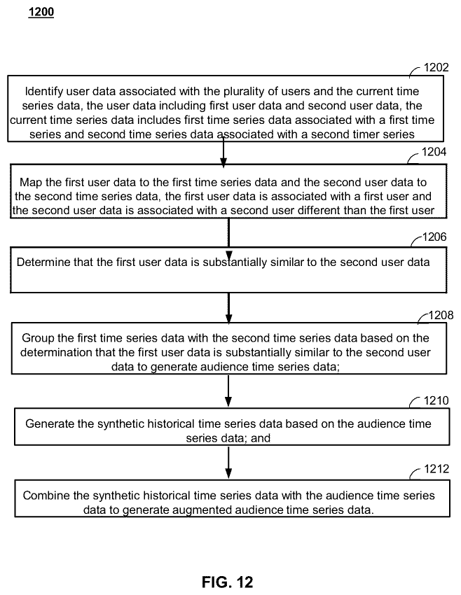

FIG. 12 is a flowchart illustrating an exemplary method 1200 for generating synthetic time series data to augment current time series data, in accordance with some embodiments of the present teaching. In some embodiments, the method 1200 can be carried out by one or more computing devices, such as the time series augmenter 102 of FIG. 1. Beginning at operation 1202, user data associated with the plurality of users and the current time series data is identified. In some embodiments, the user data includes first user data and second user data. The current time series data includes first time series data associated with a first time series and second time series data associated with a second time series. At operation 1204, the first user data is mapped to the first time series data and the second user data is mapped to the second time series data.

In some embodiments, the first user data is associated with a first user and the second user data is associated with a second user different than the first user. At operation 1206, time series augmenter 102 determines that the first user data is substantially similar to the second user data. At operation 1208, the first time series data is grouped with the second time series data based on the determination that the first user data is substantially similar to the second user data to generate audience time series data. At operation 1210, synthetic historical time series data is generated based on the audience time series data. At operation 1212, the synthetic historical time series data is combined with the audience time series data to generate augmented audience time series data.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing current time series data associated with a plurality of users;
a computing device comprising at least one processor in communication with the database, the computing device being configured to:
obtain, from the database, the current time series data, wherein the current time series data is associated with a current time period;
generate synthetic historical time series data based on the current time series data; and
combine the current time series data and the synthetic historical time series data to generate augmented time series data.

2. The system of claim 1, wherein the computing device is further configured to:
identify a start date associated with the current time series data, the start date occurring in the current time period;
identify similar time series data in the current time period, the similar time series data being similar to the current time series data and including historical time series data;
obtain, from the database, the similar time series data;
generate the synthetic historical time series data associated with the current time series data based on the similar time series data; and
combine the synthetic historical time series data with the current time series data to generate augmented similar time series data, the combining occurring at the start date such that the synthetic historical time series data predates the start date.

3. The system of claim 2, wherein the similar time series data is identified using Pearson correlation.

4. The system of claim 1, wherein the computing device is further configured to:
identify user data associated with the plurality of users and the current time series data, the user data including first user data and second user data, the current time series data includes first time series data associated with a first time series and second time series data associated with a second time series;
map the first user data to the first time series data and the second user data to the second time series data, the first user data is associated with a first user and the second user data is associated with a second user different than the first user;
determine that the first user data is substantially similar to the second user data;
group the first time series data with the second time series data based on the determination that the first user data is substantially similar to the second user data to generate audience time series data;
generate the synthetic historical time series data based on the audience time series data; and
combine the synthetic historical time series data with the audience time series data to generate augmented audience time series data.

5. The system of claim 4, wherein the first user data is mapped to the first time series data and the second user data is mapped to the second time series data using cookie impression mapping.

6. The system of claim 4, wherein the first user data is mapped to the first time series data and the second user data is mapped to the second time series data using one or more of cookie luid mapping and audience luid mapping.

7. The system of claim 1, wherein the computing device is further configured to:
train a machine learning model using the augmented time series data.

8. The system of claim 7, wherein the computing device is further configured to:
generate, using the machine learning algorithm, a prediction of advertisement impressions based on the augmented time series data.

9. The system of claim 1, wherein the current time series data does not include historical data.

10. The system of claim 1, wherein the current time series data includes irrelevant historical data.

11. The system of claim 1, wherein the current time series data is associated with a single current time series.

12. The system of claim 1, wherein the synthetic time series data includes synthetic historical time series data associated with a historical time period occurring prior to the current time period.

13. The system of claim 1, wherein the computing device is further configured to:
identify similar time series data, the similar time series data being substantially similar to one or more of the current time series data and user data associated with the current time series date;
analyze the similar time series data to determine one or more patterns; and
generate the synthetic historical time series data based on the one or more patterns.

14. A computer-implemented method, comprising:
storing, in a database, current time series data associated with a plurality of users;
receiving, from the database, the current time series data, wherein the current time series data is associated with a current time period;
generating synthetic historical time series data based on the current time series data; and
combining the current time series data and the synthetic historical time series data to generate augmented time series data.

15. The method of claim 14 further comprising
identifying similar time series data in the current time period, the similar time series data being similar to the current time series data and including historical time series data;
receiving, from the database, the similar time series data;
generating the synthetic historical time series data associated with the current time series data based on the similar time series data; and
combining the synthetic historical time series data with the current time series data to generate augmented similar time series data.

16. The method of claim 14 further comprising
identifying user data associated with the plurality of users and the current time series data, the user data including first user data and second user data, the current time series data includes first time series data associated with a first time series and second time series data associated with a second time series;
mapping the first user data to the first time series data and the second user data to the second time series data, the first user data is associated with a first user and the second user data is associated with a second user different than the first user;
determining that the first user data is substantially similar to the second user data;
grouping the first time series data with the second time series data based on the determination that the first user data is substantially similar to the second user data to generate audience time series data;
generating the synthetic historical time series data based on the audience time series data; and
combining the synthetic historical time series data with the audience time series data to generate augmented audience time series data.

17. The method of claim 16, wherein the first user data is mapped to the first time series data and the second user data is mapped to the second time series data using one or more of cookie impression mapping, cookie luid mapping, and audience luid mapping.

18. The method of claim 14 further comprising
identifying similar time series data, the similar time series data being substantially similar to one or more of the current time series data and user data associated with the current time series date;
analyzing the similar time series data to determine one or more patterns; and
generating the synthetic historical time series data based on the one or more patterns.

19. The method of claim 14, wherein the synthetic historical time series data includes synthetic historical time series data associated with a historical time period occurring prior to the current time period.

20. A non-transitory computer readable medium having instructions stored thereon, wherein the instructions, when executed by at least one processor, cause at least one device to perform operations comprising:
storing, in a database, current time series data associated with a plurality of users;
receiving, from the database, the current time series data, wherein the current time series data is associated with a current time period;
generating synthetic historical time series data based on the current time series data; and
combining the current time series data and the synthetic historical time series data to generate augmented time series data.
